(19) United States
(12) Patent Application Publication
(10) Pub. No.: US 2008/0260589 A1
(43) Pub. Date: Oct. 23, 2008

(54) Method and Apparatus for Performing Biochemical Testing in a Microenvironment

(75) Inventor: Dan Kikinis, Saratoga, CA (US)

Correspondence Address: CENTRAL COAST PATENT AGENCY, INC, 3 HANGAR WAY SUITE D, WATSONVILLE, CA, 95076, US

(73) Assignee: LEXTRON SYSTEMS, INC., Saratoga, CA (US)

(21) Appl. No.: 12/164,626

(22) Filed: Jun. 30, 2008

Related U.S. Application Data
(63) Continuation of application No. 10/166,322, filed on Jun. 18, 2002, now abandoned.
(60) Provisional application No. 60/328,948, filed on Oct. 11, 2001.

(51) Int. Cl. B01L 3/00

(52) U.S. Cl. 422/99

(57) ABSTRACT

A micro-testing lab for performing tests on biochemical and synthetic materials is provided. The testing lab includes a substrate forming the base material of the test lab; a poly silicon layer formed over the substrate; and a silicon dioxide layer deposited over the poly silicon layer, the poly silicon layer supporting a series of grooves, flow obstacles, and sensors for facilitating material flow, material separation, and material analysis. In a preferred embodiment, material is prepared in a preparation basin and introduced into a groove and propelled there through to at least one flow obstacle separating different molecules of the material to be tested and wherein upon separation, at least one sensor is utilized for performing analysis of the material. Also in preferred embodiments, the lab is field programmable and controllable through a control interface.

### CROSS-REFERENCE TO RELATED DOCUMENTS

The present invention claims priority to a U.S. provisional patent application Ser. No. 60/328,948 entitled “Highly Automated Aficro Test Lab” filed on Dec. 11, 2001 disclosure of which is incorporated herein by reference.

### FIELD OF THE INVENTION

The present invention is in the field of biochemical testing and pertains particularly to methods and apparatus for performing biochemical testing in a microenvironment.

### BACKGROUND OF THE INVENTION

The field of biochemical testing such as DNA analysis and like procedures requires a tremendous array of complex testing components and methods that depend highly on manual method carried out by the technician. Most biochemical testing apparatus also require at least a fair sample of biomaterial to be tested. To little material for testing can lead, in many cases to inconclusive results. Moreover, many separate tests performed require fresh samples each time the test is performed.

The field continues to evolve with introduction of new equipment and testing methods, however one with skill in the art will attest that much improvement is needed in the art, especially in the area of miniaturization of testing equipment for the purpose of reducing the required sample sizes for testing and in automating procedures.

What is clearly needed in the art is a highly automated and versatile biochemical-testing lab that can be provided in a miniaturized form for reliable testing on very small samples.

### SUMMARY OF THE INVENTION

In a preferred embodiment of the present invention a micro-testing lab for performing tests on biochemical and synthetic materials is provided, comprising a substrate forming the base material of the test lab, a poly silicon layer formed over the substrate, and a silicon dioxide layer deposited over the poly silicon layer, the poly silicon layer supporting a series of grooves, flow obstacles, and sensors for facilitating material flow, material separation, and material analysis. The lab is characterized in that material is prepared in a preparation basin and introduced into a groove and propelled there through to at least one flow obstacle separating different molecules of the material to be tested and wherein upon separation, at least one sensor is utilized for performing analysis of the material.

In some embodiments the substrate is a section of AM LCD manufactured glass. In others the substrate is a section of silicon wafer material. In still others the substrate is a section of polymer material. The grooves may be in the shape of a V. Further, flow obstacles may comprise a series of zigzags in the groove path. In some cases the flow obstacles include a combination of zigzags, bottlenecks, and surface treatments.

In some embodiments the surface treatment is an antigen for binding to certain molecules of the material and stopping forward progression of the bound molecules. In some cases material introduction is performed using inkjet technology. The material may be propelled through the grooves by electrodes enabled to attract or repulse charged particles of the material.

In some cases the at least one sensor is one of an electrostatic sensor, an electro-conductive sensor, an electro-dynamic sensor, a photo transmissive sensor, or a photo reflective sensor. Also in some cases there are a plurality of sensors, the sum total defining a combination of sensor types including an electrostatic sensor, an electro-conductive sensor, an electro-dynamic sensor, a photo transmissive sensor, and a photo reflective sensor. Also in some embodiments there may be at least one collector basin for temporarily collecting material at a collection point along a groove, characterized in that the material is urged into the collector basin through at least one via opening from the groove to the basin. The material may be exited out of the collector basin using inkjet technology.

In some embodiments there is a at least one separation switch for urging material from a primary groove having access to a secondary groove into the secondary groove, the switch comprising a gatekeeper electrode for attracting charged particles into the secondary groove and, a set of propulsion electrodes in the primary groove combining function with the gatekeeper electrode to divert material from the primary path to the secondary path. In some cases the material is diverted into a collector basin.

In another aspect of the present invention a field-programmable system for testing and analyzing biochemical and synthetic materials is provided, comprising a micro-testing lab having a substrate layer, a poly silicon layer and a silicon dioxide layer, the silicon dioxide layer including a series of grooves, flow obstacles, and sensors for facilitating material flow, material separation, and material analysis, a microprocessor having line access to the sensors and to a distributed system of electrodes embedded along the grooves, the electrodes adapted to urge the material through the grooves, a control-interface and display monitor having line access to the microprocessor for issuing commands to the processor related to programmable functions of the sensors and electrodes and for displaying test data, and at least one peripheral device having line access to the microprocessor and to the control-interface, the at least one device adapted to function in cooperation with at last one sensor according to trigger states. The system is characterized in that a user operating the control-interface can program test criteria automate certain test procedures and compare test results in conjunction with a material test scenario conducted on the micro-testing lab.

In some embodiments the microprocessor is embedded within the micro-testing lab. Further, in some embodiments the substrate layer is AM LCD manufactured glass. In some other embodiments substrate layer is silicon wafer material. In still others it may be polymer material. The grooves may be in the shape of a V. Further, the flow obstacles may comprise a series of zigzags in the groove path. In some cases the flow obstacles include a combination of zigzags, bottlenecks, and surface treatments. On surface treatment may be an antigen for binding to certain molecules of the material and stopping forward progression of the bound molecules.

In some cases material introduction into grooves is performed using inkjet technology. In different embodiments sensors may include one or a combination of an electrostatic sensor, an electro-conductive sensor, an electro-dynamic sensor, a photo transmissive sensor, or a photo reflective sensor. The control-interface may be a computer workstation. Further, the at least one peripheral device may be one of a UV laser, a particle counter, or a mass spectrometer.

In embodiments of the invention taught in enabling detail below, a micro-testing lab and elements for such a lab are provided in a manner to provide a broad variety of improvements in the conventional technology

### BRIEF DESCRIPTION OF THE DRAWING FIGURES

FIGS. 1A and B are overhead and section views of a micro test lab according to an embodiment of the present invention.

FIG. 2 is an overhead view of a zigzag V-groove delay section of the test lab of FIGS. 1A and B.

FIG. 3 is a section view of a V-groove of the test lab of FIGS. 1A and B exploded for more detail.

FIG. 4 is a perspective view of a broken section of the test lab of FIGS. 1A and B illustrating various components according to an embodiment of the invention.

FIG. 5 is an overhead view of a separation switch according to an embodiment of the present invention.

### DESCRIPTION OF THE PREFERRED EMBODIMENTS

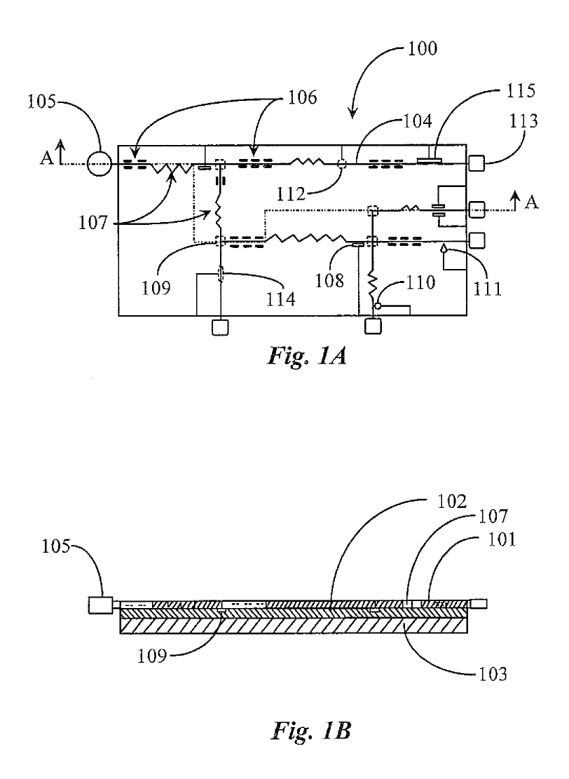

FIG. 1A is an overhead view of a micro-testing lab 100 according to an embodiment of the present invention. FIG. 1B is a section view of lab 100 taken generally along the section line AA of FIG. 1A.

Referring now to FIG. 1A, test lab 100 is in a preferred embodiment, formed on a glass or silicon substrate using standard semiconductor material coating and oxide deposition procedures. Referring now to FIG. 1B, a glass substrate 103 forms the bottom layer of lab 100. A middle layer of poly silicon 102 is provided between substrate 103 and a silicon dioxide layer 101 forming the top layer. Substrate 103 may be an LCD glass plate, a silicon wafer section, or in some embodiments another material such as a polymer material (plastics in general), ceramics etc. In this example, substrate 103 is glass. Testing Lab 100 is used to perform biochemical testing such as DNA analysis and other biochemical analysis procedures.

Poly silicon layer 102 is provided to completely cover substrate 103 in processing. Layer 102 may deposited by spin-on methods, deposition methods, or other known semiconductor coating techniques. Silicon dioxide layer 101 is deposited over layer 102 using any one of several known oxide deposition processes. If substrate 103 is a silicon wafer then a large number of testing labs can be processed on the single wafer substrate. In some cases, for example a diamond film may be used as a top layer, reducing friction for motion of particles. In other cases, localized special coatings may be used such as antigens, “sticky” and “oily” surfaces.

Referring now to FIG. 1A, a plurality of microgrooves 104 are provided in dioxide layer 101 to run in pre-defined traces or tracks along the surface of lab 100. The exact number and strategic location of grooves 104 will depend on the types of test processes that lab 100 will perform. Microgrooves 104 are pathways that bio samples (typically fluids) pass through during testing. Grooves 104 are in the design of a V shape and will hereinafter be referred to in this specification as V-grooves 104. In this example, V-grooves 104 are simply illustrated as solid one-point lines. In actual implementation, grooves 104 are typically 0.5 to 1.8 mu. V-grooves 104 may be formed in layer 101 by material etching processes or laser cutting. Processes for providing tracks or traces in semiconductor operations are well known.

Grooves 104 have delay sections 107 strategically provided at locations along the grooves path. In this case, delay is caused simply by zigzagging the path of V-groove 104 at specific locations along the groove path. Delay sections 107 may be thought of as obstacle courses that delay forward movement of bio samples through a particular section of V-groove. The zigzag configuration provides one form of material separation that may be required during a specific test. Other types of obstacles may similarly be provided at sections in the V-groove path to delay and/or provide separation of molecules in a sample being tested. That can include special coatings as mentioned above, or special geometries, such as micro holes, gel blocks, bottlenecks (<0.5 mu) etc., some of which may require special processes for manufacturing such as laser cuts, ion milling etc.

A plurality of propulsion electrodes 106 are provided embedded into dioxide layer 101 at strategic locations along V-grooves 104. Electrodes 106 are strategically grouped and arrayed in opposing pairs with V-grooves 104 passing between them. Propulsion electrodes are adapted to propel sample molecules through V-grooves 104 by charging and attracting particles in the sample. The length and frequency of pulses output by electrodes 106 can be varied to aid in separation of different molecules in a sample. For example, short high frequency pulses work better on strongly charged molecules. Varying the pulse patterns of electrodes 106 over time on a sample flow separates different molecules further apart permitting more accurate test analysis as the molecules exit delay obstacles.

At least one preparation basin 105 is provided at the lead end of a V-groove 104 and is illustrated in FIGS. 1A and B. Preparation basin 105 is adapted as a vessel where biomaterials are gathered and chemically prepared if necessary before insertion into the testing process or processes supported by test lab 100. It may be located on the carrier, or in some instances may be off-board. Ink-jet technology, micro syringes etc. can be used to pump material from the preparation basin into V-groove 104 to begin material flow for the testing process. Once the material is pumped into V-groove 104, propulsion electrodes 106 keep the material moving in a desired direction through the groove using electrodynamics propulsion.

Referring now to FIG. 1A, at least one gatekeeper electrode 109 (several illustrated) is provided within test lab 100 and strategically located at turns in the path of V-groove 104. Gatekeeper electrode 109 is embedded into poly silicon layer 102 immediately below V-groove 104 at the locations of each divergent path. Gatekeeper electrodes 109 are adapted to propel material in the direction of the divergent path. In actual practice, a set of propulsion electrodes 106 is generally implemented immediately before and after a turn point in the path of V-groove 104 the latter of which is reversed in charge to repulse material at the turn to effect divergence into the new path.

A plurality of sensors are distributed throughout lab 100 strategically located along V-groove paths and embedded in the silicon dioxide layer such that the sensing portions have access to test material as it travels through V-groove 104. Sensors illustrated in the example of FIG. 11A include electrostatic sensors 108, a light detecting sensor 115, a micro camera 111, and a photoelectric sensor 110.

Sensors 108 create an electrostatic pattern as molecules move by them. By grouping sets of these sensors Generally at the end of a refraction or delay section, electrostatic signatures of specific molecules can be generated and analyzed. Photo sensor 115 detects minute levels and changes of light specific wavelengths. A micro laser (not shown) used in conjunction with the sensor generates short laser pulses. Markers attached to the molecule can then be detected by the sensor if they emit photons that are of a wavelength within the sensor range of detection. Micro camera 111 can be used to take pictures of molecules as they pass by infrared and other to camera technologies can be used for specific test requirements. Photoelectric sensor 110 can be used to gauge the amount of material exiting the test process. Inclusion of the described sensors provided in test lab 100 should not be construed as a limitation as other sensors and sensor technologies can be employed for various testing requirements.

Catch basins 113 are provided to test lab 100 and are distributed at V-groove outlets for the purpose of catching material after it has been tested and analyzed. Catch basins 113, as well as test lab 100 as a whole can be cleaned after a test using micro scrubbing, sterilization, and other bio cleaning methods generally known in the art.

It is noted herein that leads are provided from embedded sensors that lead out from test lab 100 to various analyzing equipment and peripherals that may be associated with the specific sensors used. Counters, monitors, computer displays, light analyzers, mass spectrometers and other types of equipment may be connected to test lab 100 through typical lead frame technologies. In one embodiment, a user can program test parameters, initiate testing and receive test results using a computer workstation. The circuitry controlling the electrodes may be external to the lab carrier, or in some cases it may be partially incorporated into the silicon, using well established polysilicon on carrier technologies. The interconnect system, such as connectors, etc. will also properly align the substrate to a cradle, that forms the interface to the controlling computer etc. In some instances, it also contains lasers etc. In yet some instances, the cradle may be part of a small, handheld computing device allowing to have complete testing in the field.

In addition to the components illustrated in the example of FIG. 1A, other components not illustrated can be supported. For example, collector basins can be provided and embedded into the silicon dioxide layer and distributed at strategic access points along a V-groove path wherein material may be caused to enter the collector basin for a determined period of time before being pumped out of the basin using inkjet technology. Micro holes can also be provided for collecting very small samples of a stream of material into a collector basin in the silicon dioxide layer or into one embedded deeper into the poly silicon layer. In addition to the above, gels such as gel 114 illustrated in FIG. 1A, and other catch substance can be strategically located in certain basins having access to V-groove 104 wherein materials can later be collected and sampled manually after chemical processing by ingredients within the gel. There are many possibilities.

One with skill in the art will recognize that the components distributed in and about test lab 100 in the example of FIG. 1A can assume a wide variety of configurations strategic to certain types of tests intended to be performed. The configuration illustrated in FIG. 1A is not meant to be test specific, but is simply for discussion purposes. There may be fewer or more and differing types of components present in a test lab of the invention than are illustrated in the present example of FIGS. 1A and 1B.

It will also be apparent to one with skill in the art that many of the testing components provided are field programmable such as electrodes 106 and sensors 108, 110, and 115. Camera 110 is also field programmable. In one embodiment, a microprocessor could be provided to test lab 100 and connected to various components and functioning as a central “brain” for the lab. In this embodiment the processor would be accessed from external computing apparatus with display capabilities. In this embodiment programming can be accomplished through a single interface.

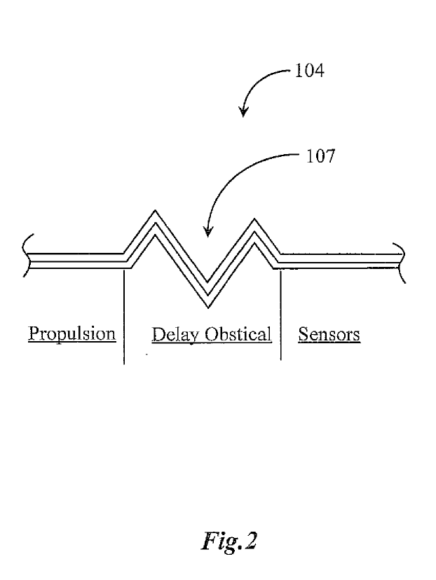

FIG. 2 is an overhead view of a zigzag V-groove delay section 107 of the test lab of FIGS. 1A and B. Delay section 107 acts to slow down longer molecules to an extent that shorter molecules in the same material will exit faster and can be analyzed separately from the longer molecules. The architectural design of delay section 107 can vary in terms of number of turns, angle of bend, length of bend, and even shape of bend. In this example an irregular obstacle is presented combining 4 turns. In other embodiments the straight sections of the obstacle can be symmetrical to one another in terms of length and angle of turn. This example more clearly illustrates the construction of V-groove 104 from an overhead perspective. The solid line running through the center of V-groove 104 represents the relatively narrow bottom of the groove.

In general, propulsion electrodes analogous to electrodes 106 described with reference to FIG. 1A would occupy the section immediately before the delay obstacle (Propulsion) to help propel the sample material through the obstacle. The section immediately after the obstacle (Sensors) is generally where sensors analogous to those sensors described with reference to the example of FIG. 1A are installed. Friction created by the obstacle causes larger or longer molecules to be delayed more than smaller molecules for a degree of separation of the different size molecules. Other geometric patterns for obstacles may be used such as, perhaps, a square pattern instead of a zigzag pattern. There are many possibilities.

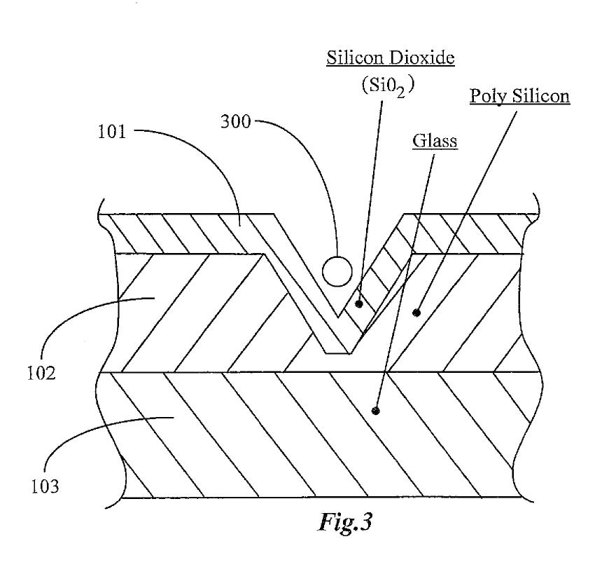

FIG. 3 is a section view of V-groove 104 of the test lab of FIGS. 1A and B exploded for more detail. As was previously described above, V-groove 104 is formed in silicon dioxide layer (Si0₂) 101. Layer 101 is deposited over poly silicon layer 102 before V-groove 104 is formed by semiconductor processes. Glass substrate 103 forms the base of the assembly. A sample material 300 is illustrated traveling through V-groove 104. The V shape of V-groove 104 is advantageous over other groove designs and facilitates very small samples. In one embodiment, special surface treatments may be applied to V-groove 104 as mechanism for separation. For example a diamond coating applied to the silicon dioxide service of a groove section provides very little motion resistance enabling smaller molecules to speed ahead of longer ones. Antigens can be applied in certain sections that bind to certain molecules stopping them from forward progression while not binding to other molecules that are allowed to pass. Certain ceramic or metallic coatings may also be useful in separating certain substances.

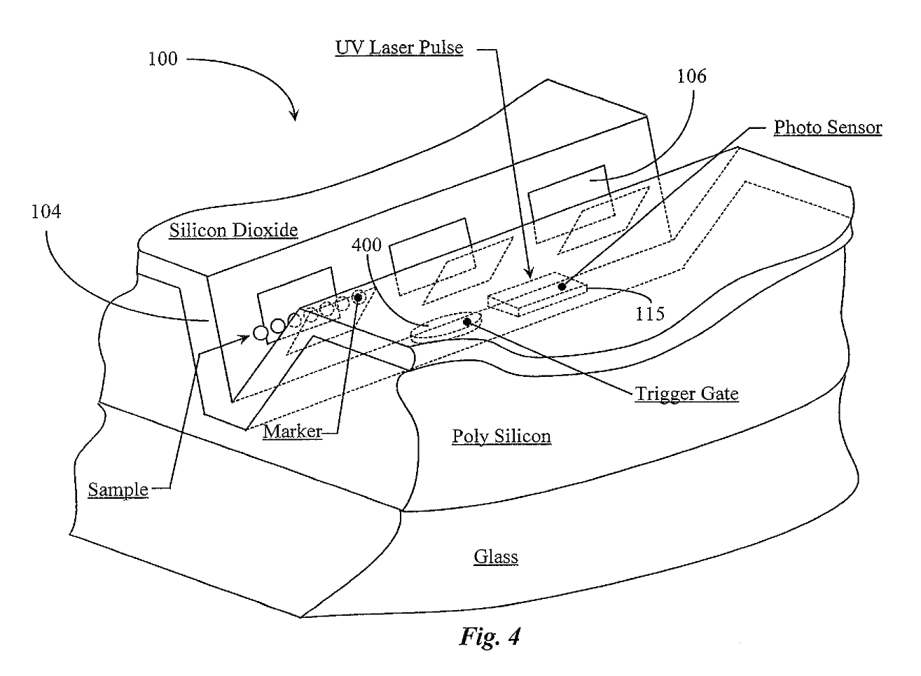

FIG. 4 is a perspective view of a broken section of test lab 100 of FIGS. 1A and B illustrating various components according to an embodiment of the invention. In this example, a propulsion section of V-groove 104 is illustrated containing propulsion electrodes 106 arrayed in opposing pairs. A sample is illustrated inside groove 104 passing in between the first set of electrodes 106 in the direction illustrated by arrow. Photo sensor 115 is illustrated embedded into the poly silicon layer beneath V-groove 104. A charged marker associated with the sample passes over a trigger gate 400 embedded into the poly silicon just ahead of sensor 115. Trigger gate 400, sensor 115 and electrodes 106 all have externally reaching leads connected thereto that lead out to control and peripheral apparatus.

In this example, trigger gate 400 detects the marker, and triggers a laser pulse or a series of pulses from an external or, in some embodiment, internal laser that is aimed at or just before the area occupied by sensor 115. Sensor 115 then detects any light emissions from the sample resulting from the laser operation. In actual practice, trigger gate 400 and photo sensor 115 are preferable located in a section void of propulsion electrodes and preferable at the end of a delay obstacle. Inclusion of the components in this example in a propulsion section is for illustrative purpose only. The area of poly silicon immediately under V-groove 104 may also contain collector basins having access to groove 104 by way of small micro openings connecting then to the inside area of the groove for collection of very small samples such as a single DNA strand. In one embodiment, certain chemicals required for sample treatments may be stored in poly-embedded basins and be injected into a sample stream as it passes by. Such basins would have additional access to the external realm through the poly or glass layer so that they may be charged with the appropriate chemicals from external sources.

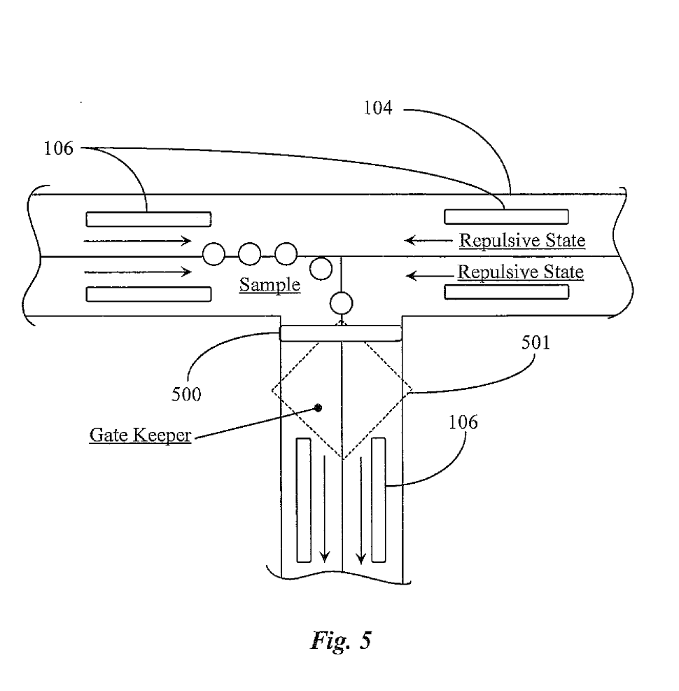

FIG. 5 is an overhead view of a separation switch configuration according to an embodiment of the present invention. As previously described, samples can be urged along divergent paths using electrodes adapted for the purpose. V-groove 104 exhibits a divergent path in this example through which a sample is diverted. In this case, a gatekeeper electrode 501 is positioned underneath and at the front entrance of the divergent course. Propulsion electrodes 106 normally propel the sample past the diverging point in the direction from left to right as viewed in this example. However, in the case of divergence of all or part of a sample, electrodes 106 placed immediately after the diverging point are switched to repulse the charged particles in the reverse direction causing the approaching sample to falter in progress at the point of divergence whereupon electrode 501 attracts them into the new track where they are further propelled down the new path by propulsion electrodes strategically 500 is provided across the entrance of the divergent path to inhibit leakage of sample material into the path when divergence is not activated. When divergence is activated the attracting force of gatekeeper electrode 501 is sufficient to pull the diverted sample over dam bar 500.

The method and apparatus of the present invention can be practiced using standard semiconductor manufacturing techniques on a silicon wafer, a glass substrate such as an AM LCD plate, or a polymer substrate. A wide range of micro tests can be facilitated for bio chemical analysis, synthetic material analysis, material aging analysis, material identification, pathogen analysis for medical purpose, and many others.

In some instances, a carrier liquid may be used to help move particles along, such as water, alcohol or any other appropriate solvent for the samples under test. In yet other cases, the whole plate may be covered (sealed) and used in combination with gases, much similar to a gas chromatograph.

The method and apparatus of the present invention, in view of the many embodiments and uses, should be afforded the broadest scope under examination. The spirit and scope of the present invention shall be limited only by the following claims.

What is claimed is:

1. A micro-testing lab for performing tests on biochemical and synthetic materials comprising:
a substrate forming the base material of the test lab;
a poly silicon layer formed over the substrate; and
a silicon dioxide layer deposited over the poly silicon layer, the poly silicon layer supporting a series of grooves, flow obstacles, and sensors for facilitating material flow, material separation, and material analysis;
characterized in that material is prepared in a preparation basin and introduced into a groove and propelled there through to at least one flow obstacle separating different molecules of the material to be tested and wherein upon separation, at least one sensor is utilized for performing analysis of the material.

2. The micro-testing lab of claim 1 wherein the substrate is a section of AM LCD manufactured glass.

3. The micro-testing lab of claim 1 wherein the substrate is a section of silicon wafer material.

4. The micro-testing lab of claim 1 wherein the substrate is a section of polymer material.

5. The micro-testing lab of claim 1 wherein the grooves are in the shape of a V.

6. The micro-testing lab of claim 1 wherein the flow obstacles comprise a series of zigzags in the groove path.

7. The micro-testing lab of claim 1 wherein the flow obstacles include a combination of zigzags, bottlenecks, and surface treatments.

8. The micro-testing lab of claim 7 wherein the surface treatment is an antigen for binding to certain molecules of the material and stopping forward progression of the bound molecules.

9. The micro-testing lab of claim 1 wherein material introduction is performed using inkjet technology.

10. The micro-testing lab of claim 1 wherein the material is propelled through the grooves by electrodes enabled to attract or repulse charged particles of the material.

11. The micro-testing lab of claim 1 wherein the at least one sensor is one of an electrostatic sensor, an electro-conductive sensor, an electro-dynamic sensor, a photo transmissive sensor, or a photo reflective sensor.

12. The micro-testing lab of claim 1 wherein there are a plurality of sensors, the sum total defining a combination of sensor types including an electrostatic sensor, an electro-conductive sensor, an electro-dynamic sensor, a photo transmissive sensor, and a photo reflective sensor.

13. The micro-testing lab of claim 1 further comprising at least one collector basin for temporarily collecting material at a collection point along a groove.
characterized in that the material is urged into the collector basin through at least one via opening from the groove to the basin.

14. The micro-testing lab of claim 13 wherein the material is exited out of the collector basin using inkjet technology.

15. The micro-testing lab of claim 10 further comprising at least one separation switch for urging material from a primary groove having access to a secondary groove into the secondary groove, the switch comprising:
a gatekeeper electrode for attracting charged particles into the secondary groove and,
a set of propulsion electrodes in the primary groove combining function with the gatekeeper electrode to divert material from the primary path to the secondary path.

16. The micro-testing lab of claim 15 wherein the material is diverted into a collector basin.

17. A field-programmable system for testing and analyzing biochemical and synthetic materials comprising:
a micro-testing lab having a substrate layer, a poly silicon layer and a silicon dioxide layer, the silicon dioxide layer including a series of grooves, flow obstacles, and sensors for facilitating material flow, material separation, and material analysis;
a microprocessor having line access to the sensors and to a distributed system of electrodes embedded along the grooves, the electrodes adapted to urge the material through the grooves;
a control-interface and display monitor having line access to the microprocessor for issuing commands to the processor related to programmable functions of the sensors and electrodes and for displaying test data; and
at least one peripheral device having line access to the microprocessor and to the control-interface, the at least one device adapted to function in cooperation with at last one sensor according to trigger states;
characterized in that a user operating the control-interface can program test criteria automate certain test procedures and compare test results in conjunction with a material test scenario conducted on the micro-testing lab.

18. The system of claim 17 wherein the microprocessor is embedded within the micro-testing lab.

19. The system claim 17 wherein the substrate layer is AM LCD manufactured glass.

20. The system of claim 17 wherein the substrate layer is silicon wafer material.

21. The system of claim 17 wherein the substrate layer is polymer material.

22. The system of claim 17 wherein the grooves are in the shape of a V.

23. The system of claim 17 wherein the flow obstacles comprise a series of zigzags in the groove path.

24. The system of claim 17 wherein the flow obstacles include a combination of zigzags, bottlenecks, and surface treatments.

25. The system of claim 24 wherein the surface treatment is an antigen for binding to certain molecules of the material and stopping forward progression of the bound molecules.

26. The system of claim 17 wherein material introduction into grooves is performed using inkjet technology.

27. The system of claim 17 wherein sensors include one or a combination of an electrostatic sensor, an electro-conductive sensor, an electro-dynamic sensor, a photo transmissive sensor, or a photo reflective sensor.

28. The system of claim 17 wherein the control-interface is a computer workstation.

29. The system of claim 17 wherein the at least one peripheral device is one of a UV laser, a particle counter, or a mass spectrometer.
